(19) United States
(12) Patent Application Publication
(10) Pub. No.: US 2015/0142379 A1
(43) Pub. Date: May 21, 2015

(54) METHOD AND APPARATUS FOR FORCING THE MEASUREMENTS OF THE ANGLES OF A TRIANGLE

(71) Applicant: Texas Instruments Incorporated, Dallas, TX (US)

(72) Inventor: Michel Georges Stella, Dallas, TX (US)

(21) Appl. No.: 14/548,721

(22) Filed: Nov. 20, 2014

Related U.S. Application Data
(60) Provisional application No. 61/906,707, filed on Nov. 20, 2013.

(51) Int. Cl. G01B 21/22; G06F 17/17

(52) U.S. Cl. CPC G01B 21/22; G06F 17/17
USPC 702/155

(57) ABSTRACT

A system, method and device for forcing the measurement of a triangle. The method includes computing angles A B C, BAC and ACB for a triangle ABC, determining the measurement of at least one of angles ABC, BAC and ACB in degrees, nudging the angles to ensure that measurements are integers and add up to 180 degrees. The method may also include determining a closest integer to the measurement of the at least one of the angles ABC, BAC and ACB, rotating segment AC of the triangle ABC around A by a′-a degrees, where a is the measurement of the at least one of angles ABC, BAC and ACB and a′ is the closest integer to the measurement of at least one of the angles ABC, BAC and ACB and wherein the new position of C is C′ and angle BAC′ is equal to a′, moving point C′ along the fixed direction of line AC′, and ensuring that the other two the angles of the triangle ABC are integers.

### CROSS REFERENCES TO RELATED APPLICATIONS

This application claims priority from U.S. Provisional Patent Application No. 61/906,707 filed on Nov. 20, 2013, which is hereby incorporated by reference in its entirety.

### BACKGROUND OF THE INVENTION

1. Field of the Invention

Embodiments of the present invention generally relate to a method and apparatus for forcing measurements of angles of a triangle. More specifically, for displaying angles of a triangle as fractions of ⁻Fr and for forcing the measurements of angles of a triangle are integer number of degrees.

2. Description of the Related Art

The internal angles of a triangle add up to 180 degrees, 200 gradians or π radians. It is possible to show the measurements of the angles so that they add up exactly to 180 degrees or 200 gradians. However, for the angles to add up exactly to π, the measurements need to be shown as rational fractions of π.

Furthermore, students first learn that the sum of the angles of a triangle is 180 degrees. However, depending on the accuracy of the measurements and the precision used in a display, the values shown on screen may not always add up to 180. Even rounding to the nearest degree is not always a solution, because the rounded value of a sum of 3 values is not always equal to the sum of the 3 rounded values. Without special processing, the values displayed on the screen may not always add up to exactly 180, which can be disconcerting for a beginner.

Therefore, there is a need for an improved method and device to allow for forcing the measurements of angles of a triangle are integer number of degrees that adds up to 180.

### SUMMARY OF THE INVENTION

Embodiments of the present invention relate to a system, method and device for forcing the measurement of a triangle. The method includes computing angles A B C, BAC and ACB for a triangle ABC, determining the measurement of at least one of angles ABC, BAC and ACB in degrees, nudging the angles to ensure that they add up to 180 degrees. The method may also include determining a closest integer to the measurement of at least one of the angles ABC, BAC and ACB, rotating segment AC of the triangle ABC around A by a′-a degrees, where a is the measurement of at least one of the angles ABC, BAC and ACB and a′ is the closest integer to the measurement of at least one of the angles ABC, BAC and ACB and wherein the new position of C is C′ and angle BAC′ is equal to a′, moving point C′ along the fixed direction of line AC′, and ensuring that the other two the angles of the triangle ABC are integers.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is an embodiment for selecting point C; and

FIG. 2 is an embodiment for a method 200 for forcing the measurements of angles of a triangle are integer number of degrees.

### DETAILED DESCRIPTION

When the user creates a triangle, the last vertex is “nudged” imperceptibly to force all 3 angles to be rational fractions of PI (π). Since there are an infinite number of possible rational fractions, we limit our “quantization” of the angles to something like π/180 or π/360.

The next step is to force the constructed angles to equal to an integer number of degrees, within a tolerance of a very small fraction of one degree. As a result, the displayed values will be integers that add up to exactly 180 degrees with a precision that is within a threshold.

A user may select points or place points to create triangles. Such points may be placed on a screen. After the first two points (A and B) are chosen, the user completes the triangle by selecting or placing point C. At such point, the position of C is changed in the immediate neighborhood of the original location chosen by the user. As a result, the measurements in degrees of all three angles of triangle ABC are integer numbers (which obviously add up to 180).

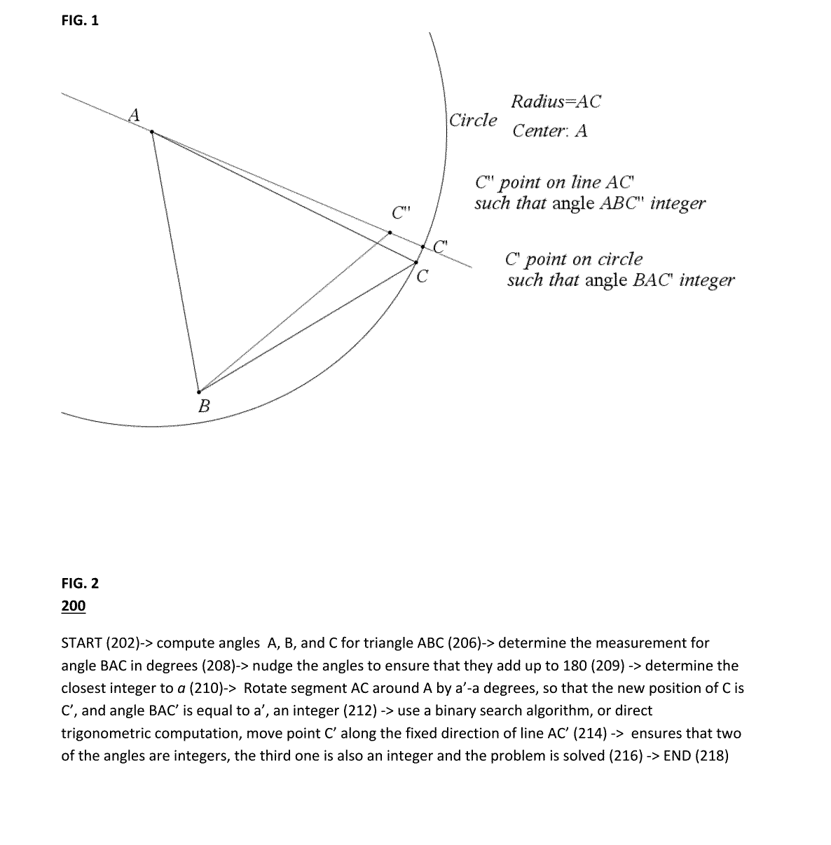

FIG. 1 is an embodiment for selecting point C. The distance between points C, C′ and C″ has been exaggerated for legibility. In reality, they would be very close to each other; thus, fulfilling the requirement for user transparency.

We want the algorithm to be as inconspicuous as possible. In other words, the final position of C is as close as possible from the original location given by the user. Thus, the user can hardly notice that the final point of the triangle was “nudged”. One possible way of achieving this is through a gradient method that would look for solutions within a small circle centered in C. Such a method may be costly in terms of computations, and become noticeable on CPU bounded systems, such as, graphing calculators, tablets, etc.

FIG. 2 is an embodiment for a method 200 for forcing the measurements of angles of a triangle are integer number of degrees. The method 200 starts at steps 202 and proceeds to step 206. At step 206, the method 200 compute three angles, A, B and C, of triangle ABC using the user chosen location for C. At step 208, the method 200 determines the measurement for angle BAC in degrees. At step 209, the method 200 nudges the angles to ensure that the y add up to 180. At step 210, the method 200 determine the closest integer to a. The difference between a and a′ is within a threshold, for example the difference is less 0.5 degrees, for example.

At step 212, the method 200 rotates segment AC around A by a′-a degrees, so that the new position of C is C′, and angle BAC′ is equal to a′, an integer. At step 214, the method 200 uses an algorithm (for example, a binary search algorithm, or direct trigonometric computation), move point C′ along the fixed direction of line AC′. The goal is to situate C in a position where the value of angle ABC is an integer (C″ is the new position of point C′). At step 216, the method 200 ensures that two of the angles are integers, the third one is also an integer and the problem is solved. Special care needs to be taken if the angle values become very small. One solution is to prevent the angle measurements to go below 1 degree of above 178 degrees. The method ends at step 218.

While the foregoing is directed to embodiments of the present invention, other and further embodiments of the invention may be devised without departing from the basic scope thereof, and the scope thereof is determined by the claims that follow.

What is claimed is:

1. A computing device, comprising:
memory for archiving data; and
processor coupled to the memory configured to perform a method, the method comprising:
computing angles A B C, BAC and ACB for a triangle ABC;
determining the measurement of at least one of angles ABC, BAC and ACB in degrees; and
nudging the angles to ensure that measurements are integers and add up to 180 degrees.

2. The computing device of claim 1, wherein the method further comprises:
determining a closest integer to the measurement of the at least one of angles ABC, BAC and ACB; and
rotating segment AC of the triangle ABC around A by a′-a degrees, where a is the measurement of the at least one of angles ABC, BAC and ACB and a′ is the closest to the measurement of the at least one of angles ABC, BAC and ACB and wherein the new position of C is C′ and angle BAC′ is equal to a′.

3. The computing device of claim 2, wherein the method utilizes at least one of a binary search algorithm and direct trigonometric computation of the optimal position.

4. The computing device of claim 2 further comprising:
moving point C′ along the fixed direction of line AC′; and
ensuring that the other two angles of the triangle ABC are integers.

5. The computing device of claim 1, wherein the computing device is at least one of a calculator, a handheld, a computer, and a tablet.

6. A method for forcing measurements of a triangle ABC, the method comprising:
computing angles A B C, BAC and ACB for the triangle ABC;
determining the measurement of at least one of angles ABC, BAC and ACB in degrees; and
nudging the angles to ensure that measurements are integers and add up to 180 degrees.

7. The method of claim 6 further comprises:
determining a closest integer to the measurement of the at least one of angles ABC, BAC and ACB; and
rotating segment AC of the triangle ABC around A by a′-a degrees, where a is the measurement of the at least one of angles ABC, BAC and ACB and a′ is the closest to the measurement of the at least one of angles ABC, BAC and ACB and wherein the new position of C is C′ and angle BAC′ is equal to a′.

8. The method of claim 7, wherein the method utilizes at least one of a binary search algorithm and direct trigonometric computation of the optimal position.

9. The method of claim 7 further comprising:
moving point C′ along the fixed direction of line AC′; and
ensuring that the other two the angles of the triangle ABC are integers.

10. The method of claim 6, wherein the method is utilized on at least one of a calculator, a handheld, a computer, and a tablet.
